(19) United States
(12) Patent Application Publication
(10) Pub. No.: US 2010/0000638 A1
(43) Pub. Date: Jan. 7, 2010

(54) TIRE HAVING A SIDEWALL WITH ENHANCED INDICIA

(76) Inventor: Scott Smith, New Haven, CT (US)

Correspondence Address: BRIDGESTONE AMERICAS, INC., 1200 FIRESTONE PARKWAY, AKRON, OH, 44317, US

(21) Appl. No.: 12/167,277

(22) Filed: Jul. 3, 2008

(51) Int. Cl. B60C 13/00

(52) U.S. Cl. 152/151

(57) ABSTRACT

A tire is provided with at least two information-bearing indicia including a first information-bearing indicium and a second information-bearing indicium. The first information-bearing indicium includes rim size information and is a larger size having a greater radial height relative to the second information-bearing indicium. The second information-bearing indicium includes information relating to at least one of an aspect ratio, section width, tire type, speed symbol, load index, mud capability, and snow capability. The first information-bearing indicium covers at least 40% of the radial height of the sidewall.

### FIELD OF INVENTION

The present application is directed to a tire having markings or indicia provided thereon. More particularly, the present application is directed to a tire having at least one enhanced indicium.

### BACKGROUND

Prior art tires include markings or indicia of uniform size on the sidewalls. Indicia can include, for example, letters, numbers, symbols or designs. The indicia bears information identifying the source of the tire by name or trademark, the size of the tire, the width of the tire, the speed rating, the maximum air pressure, and other information. Indicia may be difficult to discern on the black background of the tire sidewall. Tire manufacturers have endeavored to increase the visibility of the indicia on the sidewall of tires using numerous techniques.

One technique for increasing the visibility of the indicia on the tire sidewall involves raising or lowering at least a portion of the indicia from the outer surface of the sidewall. This technique is accomplished by molding the indicia in relief on the sidewalls of a tire; thereby creating embossed (i.e., protruding) or engraved (i.e., indented) indicia.

Another technique for increasing the visibility of the indicia on the tire sidewall involves the use of colored indicia. Colored indicia (such as a white sidewall) set on a black tire background increases the visibility of the indicia. The use of colored indicia, however, can complicate the manufacturing process.

Yet another technique for increasing the visibility of the indicia on the tire sidewall involves using serrations. The serrations can change the amount of light reflected or deflected from the tire sidewall. The variation in light reflection or deflection enhances the visibility of the indicia.

### SUMMARY

A tire is provided with at least two information-bearing indicia, including at least a first information-bearing indicium and a second information-bearing indicium. In one embodiment, the first information-bearing indicium includes rim size information and has a greater radial height than the second information-bearing indicium. The second information-bearing indicium includes information relating to at least one of an aspect ratio, section width, tire type, speed symbol, load index, mud capability, and snow capability. In another embodiment, the first information-bearing indicium includes rim size information and has a greater radial height than the second information-bearing indicium that includes section width and aspect ratio. In yet another embodiment, the first information-bearing indicium includes rim size information and covers at least 40% of the radial height of the sidewall.

### BRIEF DESCRIPTION OF THE DRAWINGS

In the accompanying drawings, embodiments of a tire including a sidewall and associated indicia are illustrated, which, together with the detailed description given below, serve to describe exemplary embodiments of the tire. It will be appreciated that the illustrated boundaries of indicia in the figures represent one example of the boundaries. It should be understood that, one indicium may be designed as multiple indicia or multiple indicia may be designed as a single indicium. It should also be understood that, an indicium shown as an internal component of another indicium may be implemented as an external component and vice-versa.

Further, in the accompanying drawings and description that follow, like parts are indicated throughout the drawings and description with the same reference numerals, respectively. The figures are not drawn to scale and the proportions of certain parts have been exaggerated for convenience of illustration.

FIG. 1A illustrates a partial side elevation view of one embodiment of a tire 100 having a sidewall with information-bearing indicia provided thereon;

FIG. 1B is a cross-section of a portion of the first information-bearing indicium 120, along the line A-A of FIG. 1A;

FIG. 1C is a cross-section of the second information-bearing indicium 125 along the line B-B of FIG. 1A;

FIG. 2A illustrates a partial side elevation view of another embodiment of a tire 200;

FIG. 2B is a cross-section of the second information-bearing indicium 225 along the line C-C of FIG. 2A;

FIG. 3A illustrates a partial side elevation view of an alternative embodiment of a tire 300 having a sidewall with information-bearing indicia provided thereon;

FIG. 3B is a cross-section of a portion of the first information-bearing indicium 320, along the line D-D of FIG. 3A; and

FIG. 3C is a cross-section of the second information-bearing indicium 325 along the line E-E of FIG. 3A.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Axial” and “axially,” as used herein, refer to a direction that is parallel to the axis of rotation of a tire.

“Bead” refers to the part of the tire that contacts the wheel and defines a boundary of the sidewall.

“Circumferential” and “circumferentially,” as used herein, refer to a direction extending along the perimeter of the surface of the annular tread perpendicular to the axial direction.

“Equatorial plane” refers to the plane that is perpendicular to the tire's axis of rotation and passes through the center of the tire's tread.

“Lateral,” as used herein, refers to a direction along the tread of the tire going from one sidewall of a tire to the other sidewall.

“Off-shoulder region,” as used herein, refers to the upper portion of each sidewall just below the edge of the tread.

“Radial” and “radially,” as used herein, refer to a direction perpendicular to the axis of rotation of a tire.

“Sidewall,” as used herein, refers to that portion of the tire between the tread and the bead.

“Tread,” as used herein, refers to that portion of the tire that comes into contact with the road under normal inflation and load.

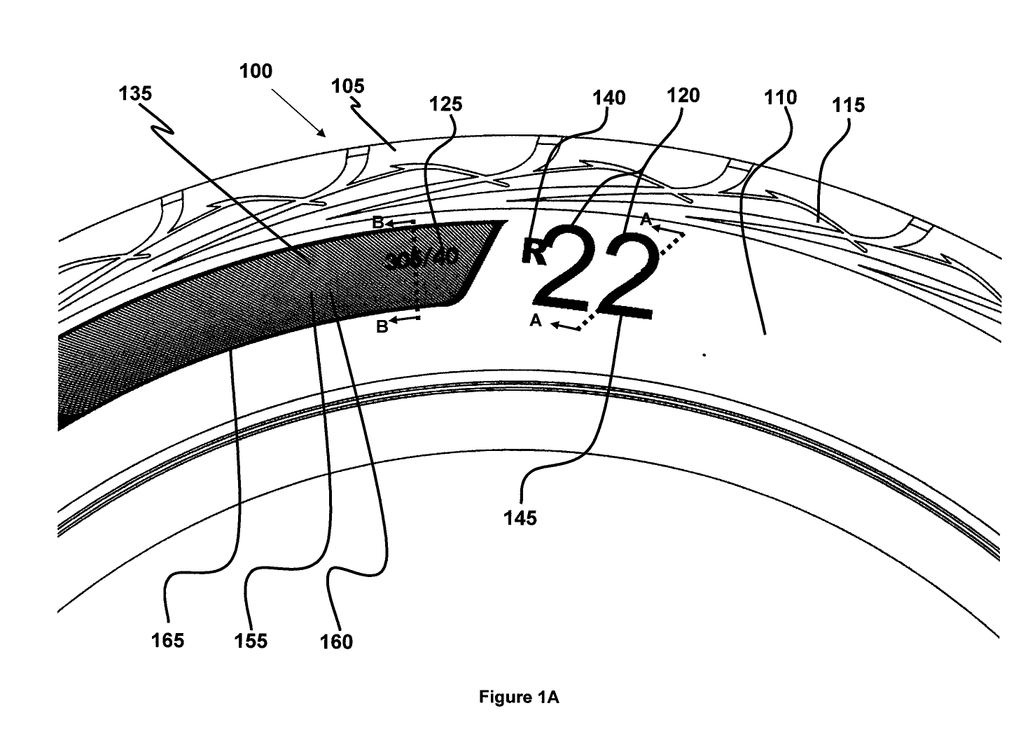

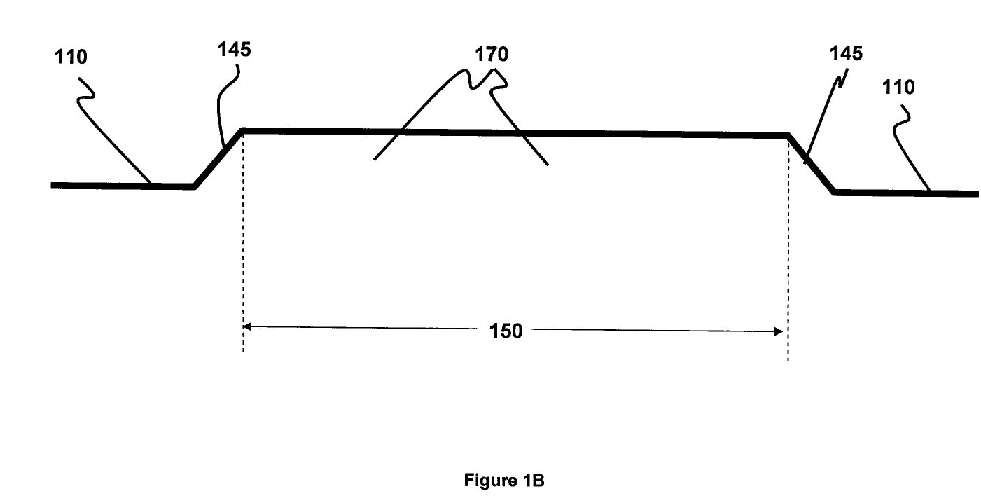

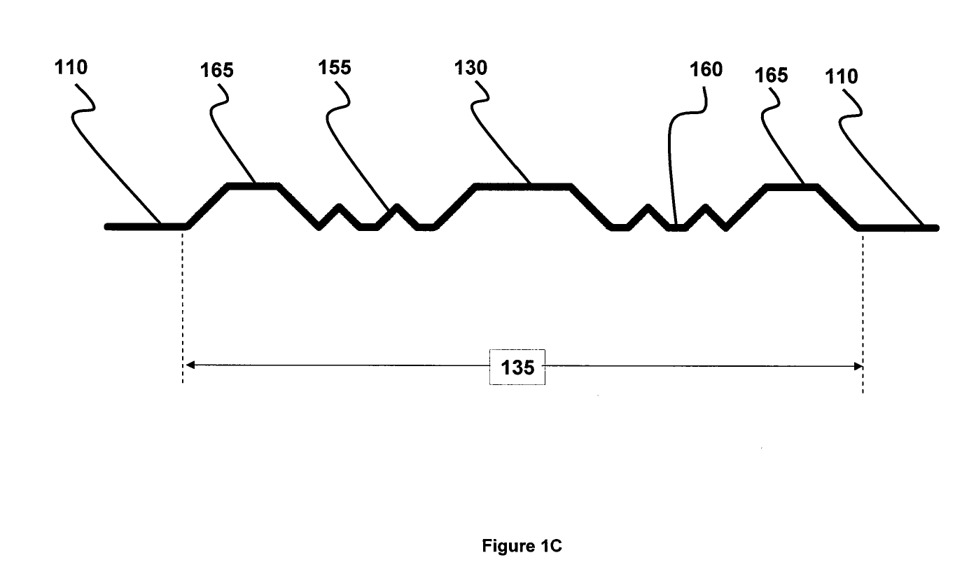

FIG. 1A is a partial side elevation view of one embodiment of a tire 100 having a circumferential tread 105, a sidewall 110, and an off-shoulder region 115. The sidewall 110 includes a first information-bearing indicium 120 and a second information-bearing indicium 125. In another embodiment (not shown), the off-shoulder region 115 includes at least one of the following: a first information-bearing indicium 120 and a second information-bearing indicium 125. In yet another embodiment (not shown), the sidewall 110 and off-shoulder region 115 include at least one of the following: a first information-bearing indicium 120 and a second information-bearing indicium 125.

In the illustrated embodiment, the first information-bearing indicium 120 includes rim size information (e.g., the numeral 22 indicates that the illustrated tire is adapted for use with 22″ diameter wheels). In the illustrated embodiment, the first information-bearing indicium 120 is a larger size having a greater radial height relative to the second information-bearing indicium 125. In other words, the first information-bearing indicium 120 has greater visibility than the second information-bearing indicium 125 and may be referred to as an “enhanced indicium.”

In the illustrated embodiment, the first information-bearing indicium 120 is about 400% larger in radial height relative to the second information-bearing indicium 125. The first information-bearing indicium 120 may include at least one of the following types of indicia: a letter, numeral, symbol, logo, word, trademark, ornamental design, solid fill, and indented portions. In an alternative embodiment (not shown), the first information-bearing indicium 120 is a different color than the sidewall 110. In another alternative embodiment (not shown), the first information-bearing indicium 120 includes a decorative pattern or serrations.

In the illustrated embodiment of FIG. 1A, the first information-bearing indicium 120 is in the upper sidewall section, such that the midpoint of the indicium is offset radially above the midpoint of the sidewall 110. In an alternative embodiment (not shown), the first information-bearing indicium 120 is in the lower sidewall section, such that the midpoint of the indicium is offset radially below the midpoint of the sidewall 110. In another embodiment (not shown), the midpoint of the first information-bearing indicium 120 is located approximately at the radial midpoint of sidewall 110.

In the illustrated embodiment, the first information-bearing indicium covers at least 40% of the radial height of the sidewall 110. In another embodiment (not shown), the first information-bearing indicium 120 covers between about 40% to about 100% of the radial height of the sidewall 110. In yet another embodiment (not shown), the first information-bearing indicium 120 covers between about 45% to about 80% of the radial height of the sidewall 110. In such an embodiment, the midpoint of the first information-bearing indicium 120 can be at the radial midpoint of the sidewall 110, offset above the radial midpoint of the sidewall 110, or offset below the radial midpoint of the sidewall 110.

With continued reference to FIG. 1A, the second information-bearing indicium 125 includes section width and aspect ratio information. In an alternative embodiment (not shown), the second information-bearing indicium 125 includes information relating to at least one of the following: aspect ratio, section width, tire type (e.g., passenger or truck types), speed symbol, load index, mud capability, and snow capability. In yet another alternative embodiment (not shown), the second information-bearing indicium 125 includes at least one of the following types of indicia: a letter, numeral, symbol, logo, word, and trademark.

In the illustrated embodiment, an inner portion 135 filled with serrations 155 adjacent recessed surfaces 160 surrounds the second information-bearing indicium 125. In the illustrated embodiment, the serrations 155 and adjacent recessed surfaces 160 can vary in size and number. In an alternative embodiment (not shown), the second information-bearing indicium is surrounded by at least one of the following, a letter, numeral, symbol, logo, word, trademark, ornamental design, decorative pattern, outline, or solid fill of a different color. In yet another embodiment (not shown), the second information-bearing indicium is surrounded only by the sidewall 110.

With continued reference to FIG. 1A, the sidewall 110 further includes a radial designation “R” 140. In the illustrated embodiment, the radial designation “R” 130 is part of the first information-bearing indicium 120 and is larger than the second information-bearing indicium 125. In an alternative embodiment (not shown), the radial designation “R” 140 is not part of the first information-bearing indicium 120 and is the same size as the second information-bearing indicium 125. In another alternative embodiment (not shown), the radial designation “R” 140 is not part of the first information-bearing indicium 120 and is smaller than the second information-bearing indicium 125.

In another alternative embodiment (not shown), the radial designation “R” 140 is a third information-bearing indicium that is not part of the first information-bearing indicium 120 or the second information-bearing indicium 125. In such an embodiment, the radial designation “R” 140 is a third information-bearing indicium that is larger than the second information-bearing indicium 125 and all other information-bearing indicia, but not larger than the first information-bearing indicium 120. In yet another alternative embodiment (not shown), the radial designation “R” 140 is a third information-bearing indicium that is larger than the first information-bearing indicium 120, second information-bearing indicium 125, and all other information-bearing indicia.

FIG. 1B is a cross-section of the first information-bearing indicium 120 along the line A-A of FIG. 1A. In the illustrated embodiment, the first information-bearing indicium consists of the combination of a tire surface or the sidewall 110, a pair of ridges 145 that define the perimeter of the first information-bearing indicium 120, and an inner portion 150 that includes a solid fill portion 170. In an alternative embodiment (not shown), the inner portion 150 consists of one or more of a letter, numeral, symbol, logo, word, trademark, ornamental design, decorative pattern, an indented portion, and a plurality of serrations adjacent recessed surfaces. In yet another alternative embodiment (not shown), the first information-bearing indicium 120 is a different color than the sidewall 110. In another alternative embodiment (not shown), the ridges 145 of the first information-bearing indicium 120 are a different color than the sidewall 110 and the inner portion 150. In another embodiment (not shown), the ridges 145 are replaced with indented grooves that define the perimeter of the first information-bearing indicium 120.

FIG. 1C is a cross-section of the second information-bearing indicium 125 along the line B-B of FIG. 1A. In the illustrated embodiment, the second information-bearing indicium 125 is defined by a protruding perimeter 165 and includes inner portion 135. Inner portion 135 includes central ridge 130, recessed surface 160, and serrations 155 adjacent recessed surface 160. In another embodiment (not shown), the pitch or distance between serrations 155 and adjacent recessed surface 160 can be greater or less than the distances shown in FIG. 1C. In another embodiment (not shown), the protruding perimeter 165 is replaced with an indented groove that defines the perimeter of the second information-bearing indicium 125.

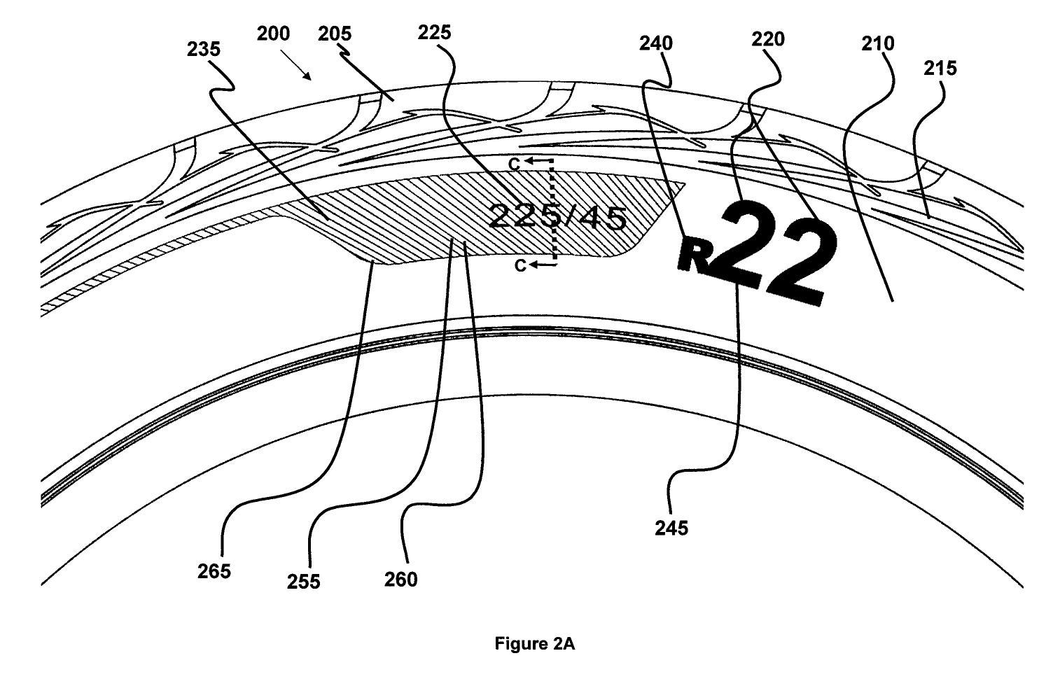

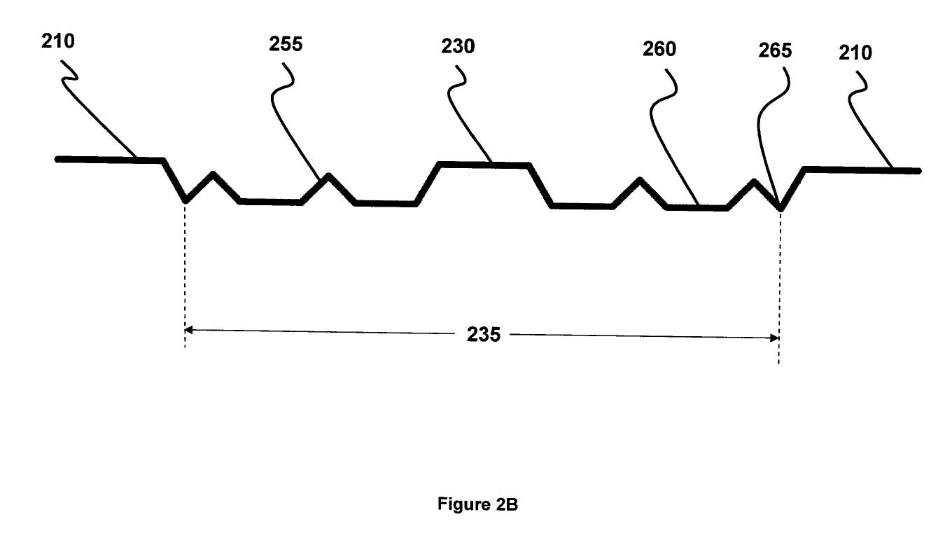

FIG. 2A is another illustrated embodiment of a tire 200 where the first information-bearing indicium 220 is about 125% larger in radial height relative to the second information-bearing indicium 225. The tire 200 is substantially the same as the tire 100 of FIG. 1A, except a second information-bearing indicium 225 is surrounded by an inner portion 235 that has an alternative type of serration 255 adjacent recessed surfaces 260. In an alternative embodiment (not shown), the first information-bearing indicium 220 is between about 125% to about 500% larger in radial height relative to the second information-bearing indicium 225. In yet another alternative embodiment (not shown), the first information-bearing indicium 220 is between about 150% to about 450% larger in radial height relative to the second information-bearing indicium 225. In another alternative embodiment (not shown), the first information-bearing indicium 220 is larger in radial height relative to all other information-bearing indicia.

FIG. 2B is a cross-section of the second information-bearing indicium 225 along the line C-C of FIG. 2A. In the illustrated embodiment, the second information-bearing indicium 225 is defined by indented perimeter 265 and includes inner portion 235. Inner portion 235 includes central ridge 230, recessed surface 260, and serrations 255 adjacent recessed surface 260. In another embodiment (not shown), the pitch or distance between serrations 255 and adjacent recessed surfaces 260 can be greater or less than the distances shown in FIG. 2A. In another embodiment (not shown), the indented perimeter 265 is replaced with a protruding ridge that defines the perimeter of the second information-bearing indicium 225.

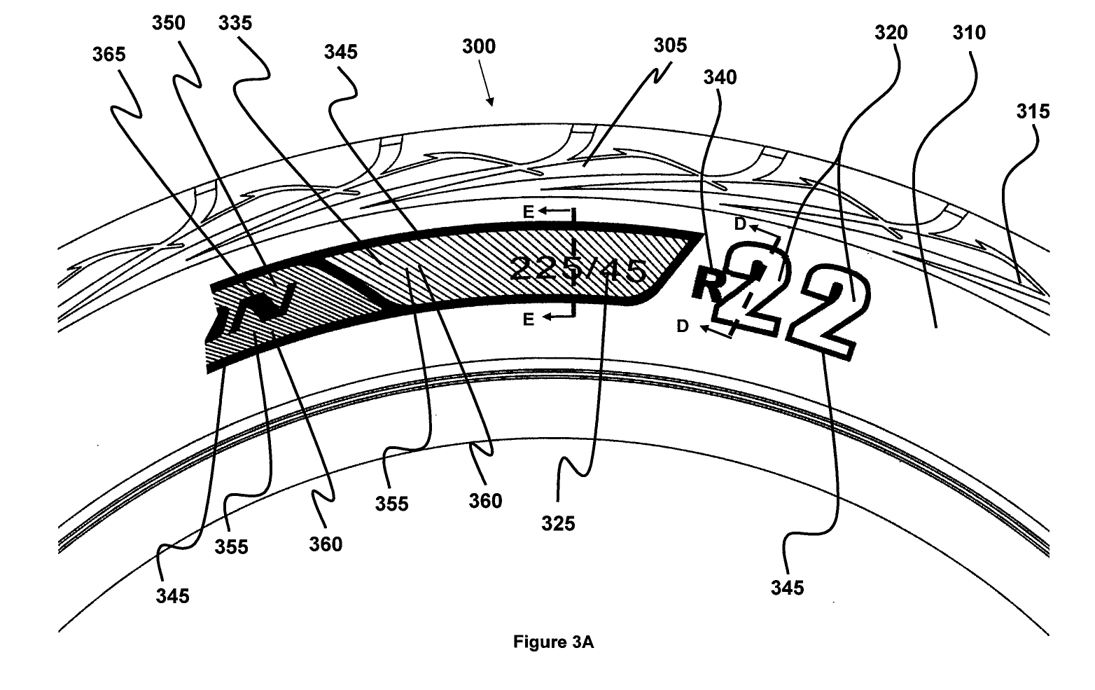

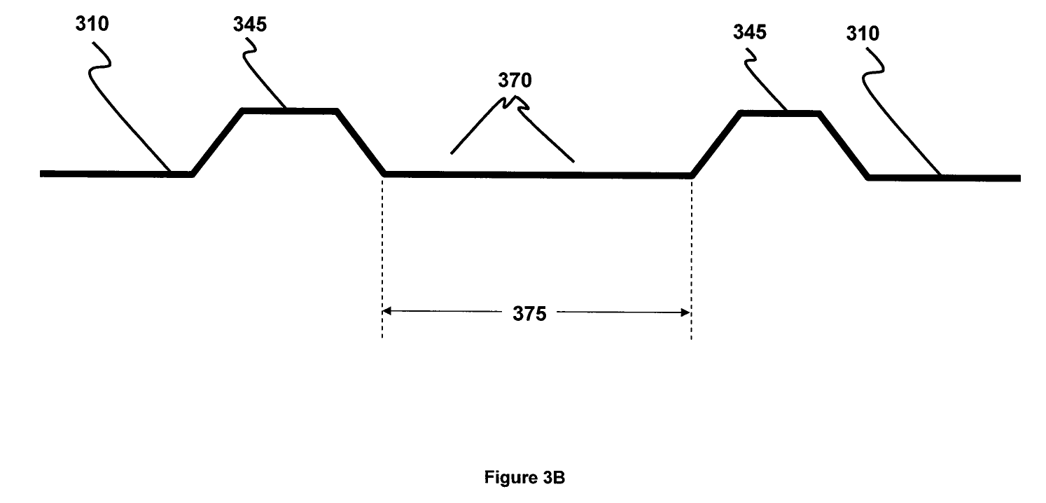

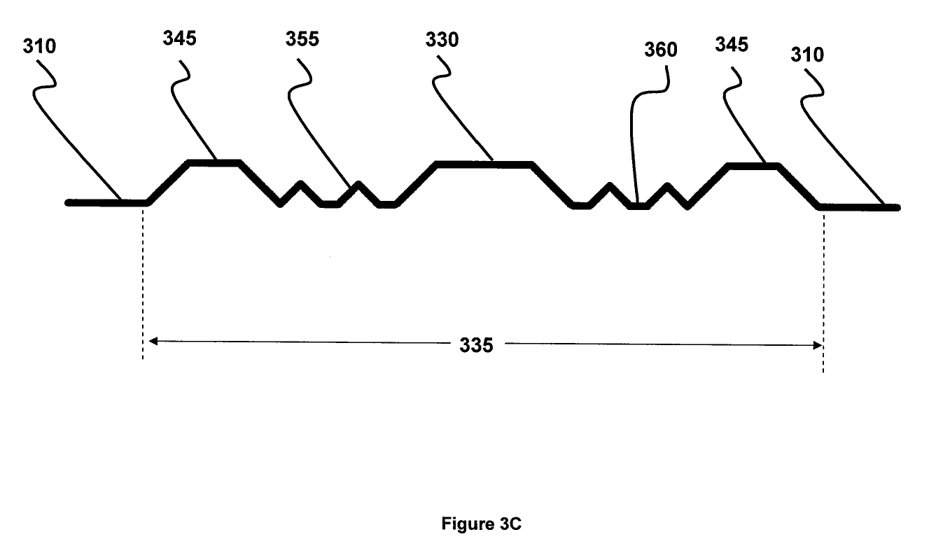

FIG. 3A is a partial side elevation view of an alternative embodiment of a tire 300 having a circumferential tread 305, a sidewall 310, and an off-shoulder region 315. The tire 300 is substantially the same as the tire 200 of FIG. 2A, except the first information-bearing indicium 320 has an indented portion (discussed below). In addition, the second information-bearing indicium 325 is surrounded by an inner portion 335 that has an alternative type of serration 355 adjacent recessed surfaces 360. Further, the inner potion 335 is defined by a perimeter 345 and includes additional serrations 350 and an additional information-bearing indicium 365 adjacent to the location of the second information-bearing indicium 325 and inner portion 335. In the illustrated embodiment, the additional serrations 350 and additional information-bearing indicium 365 have a different cross-section and orientation, compared to section C-C, discussed above in FIG. 2B. In another embodiment, the additional serrations 350 and additional information-bearing indicium 365 have the same cross-section and orientation as section C-C. In yet another embodiment (not shown), the pitch or distance between serrations 355 and adjacent recessed surfaces 360 can be greater or less than the distances shown in FIG. 3A or may include a nonlinear pattern. In another alternative embodiment (not shown), the additional serrations 350 are replaced with a different shape and/or are filled with at least one of, a letter, numeral, symbol, logo, word, trademark, ornamental design, decorative pattern, and a solid fill. In yet another alternative embodiment (not shown), the additional serrations 350 are omitted or located in another area of the sidewall 310.

FIG. 3B is a cross-section of a portion of the first information-bearing indicium 320 along the line D-D of FIG. 3A. In the illustrated embodiment, the cross-section of a portion of the first information-bearing indicium 320 along the line D-D of FIG. 3A is substantially the same as the cross-section of a portion of the first information-bearing indicium 120 along the line A-A of FIG. 1A, except the first information-bearing indicium includes a pair of ridges 345, an indented portion 370, and an inner portion 375. The pair of ridges 345 define the perimeter of the first information-bearing indicium 320. In an alternative embodiment (not shown), the inner portion 375 includes a plurality of serrations adjacent recessed surfaces and the pitch or distance between the serrations or the adjacent recessed surfaces can be more than or less than that illustrated in FIG. 3C, discussed below. In another alternative embodiment (not shown), the ridges 345 are replaced with indented grooves that define the perimeter of the first information-bearing indicium 320.

FIG. 3C is a cross-section of the second information-bearing indicium 325 along the line E-E of FIG. 3A. In the illustrated embodiment, the second information-bearing indicium 325 is defined by a pair of ridges 345 and includes inner portion 335. Inner portion 335 includes a pair of ridges 345, central ridge 330, recessed surface 360, and serrations 355 adjacent recessed surface 360. In an alternative embodiment (not shown), the pair of ridges 345 are replaced with by a pair of indented grooves.

In an alternative embodiment (not shown), the second information-bearing indicium 325 is a different color relative to the inner portion 335 and the sidewall 310. In yet another embodiment (not shown), the second information-bearing indicium 325 is surrounded by the sidewall 310. In an alternative embodiment (not shown), the recessed surface 360 protrudes away from the equatorial plane of tire 300. In an alternative embodiment (not shown), the inner portion 335 consists of one or more of a letter, numeral, symbol, logo, word, trademark, ornamental design, decorative pattern, solid fill, no fill, and serration. In an alternative embodiment (not shown), the inner portion 335 is a different color relative to the second information-bearing indicium 325 and the sidewall 310.

In an alternative embodiment (not shown), the indicia are made highly visible by making the indicia a different color relative to the sidewall. In yet another embodiment (not shown), at least one of the indicium is made highly visible by making the at least one indicium a different color relative to the sidewall and any other indicia. In still another embodiment (not shown), the indicia are made highly visible by applying materials to or within the indicia that improve the reflective properties. In still another embodiment (not shown), at least one indicium is made highly visible by making the indicium of different material relative to the sidewall and any other indicia.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modem Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed is:

1. A tire having a pair of sidewalls, the tire comprising:
at least two information-bearing indicia, including
a first information-bearing indicium providing rim size information; and
a second information-bearing indicium, providing information relating to at least one of an aspect ratio, section width, tire type, speed symbol, load index, mud capability, and snow capability;
wherein the first information-bearing indicium is a larger size having a greater radial height relative to the second information-bearing indicium.

2. The tire of claim 1, wherein the first information-bearing indicium is about 125% to about 500% larger in radial height relative to the second information-bearing indicium.

3. The tire of claim 1, wherein the first information-bearing indicia includes a perimeter and an inner portion.

4. The tire of claim 3, wherein the perimeter protrudes from an outer surface of the sidewall and defines an outline of the inner portion.

5. The tire of claim 4, wherein the inner portion includes at least one of a solid fill, letter, numeral, symbol, logo, word, trademark, ornamental design, decorative pattern, and serration.

6. The tire of claim 3, wherein the perimeter indents from an outer surface of the sidewall and defines an outline of the inner portion.

7. The tire of claim 6, wherein the inner portion includes at least one of a solid fill, letter, numeral, symbol, logo, word, trademark, ornamental design, decorative pattern, and serration.

8. The tire of claim 1, wherein the second information-bearing indicium is surrounded by at least one of a perimeter, serrations, sidewall, letter, numeral, symbol, logo, word, trademark, ornamental design, decorative pattern, and solid fill of a different color.

9. A tire having a pair of sidewalls, the tire comprising:
at least two information-bearing indicia, including
a first information-bearing indicium providing rim size information; and
at least one additional information-bearing indicium providing information relating to an aspect ratio and a section width;
wherein the first information-bearing indicium is a larger size having a greater radial height relative to the second information-bearing indicium.

10. The tire of claim 9, wherein the first information-bearing indicium is about 125% to about 500% larger in radial height relative to the plurality of additional information-bearing indicium.

11. The tire of claim 10, wherein the first information-bearing indicia includes a perimeter and an inner portion.

12. The tire of claim 11, wherein the perimeter protrudes from an outer surface of the sidewall and defines an outline of the inner portion and wherein the inner portion includes at least one of a solid fill, letter, numeral, symbol, logo, word, trademark, ornamental design, decorative pattern, and serration.

13. The tire of claim 11, wherein the perimeter indents from an outer surface of the sidewall and defines an outline of the inner portion and wherein the inner portion includes at least one of a solid fill, letter, numeral, symbol, logo, word, trademark, ornamental design, decorative pattern, and serration.

14. The tire of claim 9, wherein the second information-bearing indicium is surrounded by at least one of a perimeter, an outline portions, serrations, sidewall, letter, numeral, symbol, logo, word, trademark, ornamental design, decorative pattern, and solid fill of a different color.

15. A tire having a pair of sidewalls and a pair of off-shoulder regions, the tire comprising:
at least two information-bearing indicia, including
a first information-bearing indicium providing rim size information; and
a second information-bearing indicium providing information relating to at least one of an aspect ratio, nominal tire width, nominal height, manufacturer, type of tire, speed symbol, treadwear grade, traction grade, temperature grade, mud capability, and snow capability;
wherein the first information-bearing indicium covers at least 40% of a total height of a sidewall and off-shoulder region.

16. The tire of claim 15, wherein the first information-bearing indicium covers between about 40% to about 90% of the total height of the sidewall and off-shoulder region.

17. The tire of claim 15, wherein the first information-bearing indicium is different relative to the second information-bearing indicium in at least one of the following: a different color and a different material.

18. The tire of claim 15, wherein the first information-bearing indicium is at least one of the following: coated with a light reflecting material and impregnated with a light reflecting material.

19. The tire of claim 15, wherein the first information-bearing indicium has a radial midpoint that is offset from a radial midpoint of the sidewall and off-shoulder region of the tire.

20. The tire of claim 19, wherein the radial midpoint of the first information-bearing indicium is offset to at least one of the following: above the radial midpoint of the sidewall and off-shoulder region of the tire and below the radial midpoint of the sidewall and off-shoulder region of the tire.
